(19) United States
(12) Patent Application Publication
(10) Pub. No.: US 2025/0240854 A1
(43) Pub. Date: Jul. 24, 2025

(54) LIGHT DRIVER WITH ACCURATE DIMMING CONTROL

(71) Applicant: ERP POWER, LLC, Westlake Village, CA (US)

(72) Inventors: James H. Mohan, Valencia, CA (US); Michael Archer, Moorpark, CA (US); Louis Chen, Simi Valley, CA (US)

(21) Appl. No.: 18/986,387

(22) Filed: Dec. 18, 2024

Related U.S. Application Data
(60) Provisional application No. 63/616,089, filed on Dec. 29, 2023.

(51) Int. Cl. H05B 45/14; H05B 45/34; H05B 45/345; H05B 45/355; H05B 45/36; H05B 45/38; H05B 45/59; H05B 47/17

(52) U.S. Cl. CPC H05B 45/14; H05B 45/34; H05B 45/345; H05B 45/355; H05B 45/36; H05B 45/38; H05B 45/59; H05B 47/17

(57) ABSTRACT

A method of operating a light driver includes operating the light driver in a constant voltage mode, identifying a calibration pattern at a dimmer input of the light driver, generating a maximum voltage at an output of the light driver, measuring a maximum current at the output of the light driver, and operating the light driver in a constant current mode based on the maximum current and a dimmer level at the dimmer input.

### CROSS-REFERENCE TO RELATED APPLICATION(S)

This application claims priority to, and the benefit of, U.S. Provisional Application No. 63/616,089 (“LIGHT DRIVER WITH ACCURATE DIMMING CONTROL”), filed on Dec. 29, 2023.

### FIELD

Aspects of the present invention are related to light drivers.

### BACKGROUND

A light emitting diode (LED) is an electronic device that converts electrical energy (commonly in the form of electrical current) into light. The light intensity of an LED is primarily based on the magnitude of the driving current, which is provided by an LED driver. In the related art, LED drivers generally operate under constant-voltage mode, that is, they regulate their output to a particular output voltage. However, because the internal current of the LED depends on the type of LED, the internal series resistance of the LED, etc., which the LED driver is generally not aware of, the LED driver cannot control how much current is actually passing through the LEDs. Therefore, the LED driver may not be able to accurately set the light output of the LED. This may make it difficult for LED driver to achieve accurate low dimming (such as 1% dimming).

The above information disclosed in this Background section is only for enhancement of understanding of the invention, and therefore it may contain information that does not form the prior art that is already known to a person of ordinary skill in the art.

### SUMMARY

Aspects of embodiments of the present disclosure are directed to a light driver configured to produce accurate low dimming down to about 1% dimming. In some embodiments, the light driver is configured to operate under constant voltage in order to perform current dimming calibration and to switch to constant current mode to achieve accurate low dimming once calibration is complete.

According to some embodiments of the present disclosure, there is provided a method of operating a light driver, the method including: operating the light driver in a constant voltage mode; identifying a calibration pattern at a dimmer input of the light driver; generating a maximum voltage at an output of the light driver; measuring a maximum current at the output of the light driver; and operating the light driver in a constant current mode based on the maximum current and a dimmer level at the dimmer input.

In some embodiments, the operating the light driver in the constant voltage mode includes: measuring an output voltage of the light driver as a sampled voltage; and regulating the output voltage of the light driver based on the sampled voltage and the dimmer level.

In some embodiments, the regulating the output voltage of the light driver includes: generating a reference signal for controlling the output voltage based on the sampled voltage and the dimmer level and by disregarding current measurements at the output of the light driver.

In some embodiments, the identifying the calibration pattern at the dimmer input includes: detecting a plurality of changes in the dimmer level at the dimmer input within a period of time.

In some embodiments, each of the plurality of changes in the dimmer level is a change of 40% or more in the dimmer level.

In some embodiments, the maximum voltage is a maximum voltage rating of the light driver.

In some embodiments, the operating the light driver in the constant current mode includes: measuring an output current of the light driver as a sampled current; and regulating the output current of the light driver based on the sampled current and the dimmer level, and the.

In some embodiments, the regulating the output current of the light driver includes: generating a reference signal for controlling the output current based on the sampled current and the dimmer level.

In some embodiments, the light driver includes: a transformer defining a primary side and a secondary side of the light driver that are electrically isolated from one another; and a secondary controller at the secondary side of the light driver and configured to generate the reference signal for transmission to a primary controller at the primary side of the light driver.

In some embodiments, the light driver is configured to drive a light source, and the dimmer input of the light driver is communicatively coupled to, and is configured to receive the dimmer level from, a dimmer.

According to some embodiments of the present disclosure, there is provided a light driver including: a converter configured to drive a light source at an output of the light driver; a controller configured to perform: controlling the converter to drive the light source in a constant voltage mode; identifying a calibration pattern at a dimmer input of the controller; controlling the converter to generate a maximum voltage at the output of the light driver; measuring a maximum current at the output of the light driver; and controlling the converter to drive the light source in a constant current mode based on the maximum current and a dimmer level at the dimmer input.

In some embodiments, the controlling the converter to drive the light source in the constant voltage mode includes: measuring, by the controller, an output voltage of the converter as a sampled voltage; and regulating, by the controller, the output voltage of the converter based on the sampled voltage and the dimmer level.

In some embodiments, the regulating the output voltage of the light driver includes: generating, by the controller, a reference signal for controlling the output voltage based on the sampled voltage and the dimmer level and by disregarding current measurements at the output of the converter.

In some embodiments, the identifying the calibration pattern at the dimmer input includes: detecting, by the controller, a plurality of changes in the dimmer level at the dimmer input within a period of time.

In some embodiments, each of the plurality of changes in the dimmer level is a change of 40% or more in the dimmer level.

In some embodiments, the maximum voltage is a maximum voltage rating of the light driver.

In some embodiments, the controlling the converter to drive the light source in the constant current mode includes: measuring, by the controller, an output current of the converter as a sampled current; and

regulating, by the controller, the output current of the converter based on the sampled current and the dimmer level.

In some embodiments, the regulating the output current of the light driver includes: generating, by the controller, a reference signal for controlling the output current based on the sampled current and the dimmer level.

In some embodiments, the light driver further includes: a rectifier configured to rectify an input line voltage to generate a rectified input line voltage, wherein the converter is configured to convert the rectified input line voltage into a drive signal for powering the light source, wherein the input line voltage from which the rectified input line voltage is generated is from 100 Vac to 277 Vac.

In some embodiments, the dimmer input of the dimmer input of the controller is communicatively coupled to, and is configured to receive the dimmer level from, a dimmer.

### BRIEF DESCRIPTION OF THE DRAWINGS

The accompanying drawings, together with the specification, illustrate example embodiments of the present invention, and, together with the description, serve to explain the principles of the present invention.

FIG. 1 illustrates a lighting system including a light driver with accurate dimming control, according to some example embodiments of the present disclosure.

FIG. 2 illustrates the light driver including an output correction circuit capable of accurate dimming control according to some embodiments of the present disclosure.

FIG. 3 is a flow diagram illustrating a process of enabling accurate dimming of a light source by the light driver, according to some embodiments of the present disclosure.

### DETAILED DESCRIPTION

The detailed description set forth below is intended as a description of example embodiments of a light driver with accurate dimming, provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

LED drivers in the related art face several disadvantages. The inability to control the exact current passing through the LEDs results in inaccurate light output. This inaccuracy becomes particularly problematic when attempting to achieve low dimming levels, such as 1% dimming. Additionally, the reliance on constant-voltage mode without accounting for variations in LED characteristics can lead to inconsistencies in light output, flicker, and shimmer, especially at low dimming levels. These issues are exacerbated by the lack of precise current measurement and control mechanisms in existing LED drivers.

Aspects of embodiments of the present disclosure are directed to a light driver (e.g., an LED driver) configured to produce accurate low dimming down to about 1% dimming. In some embodiments, the light driver is configured to operate under constant voltage in order to perform current dimming calibration and to switch to constant current mode to achieve accurate low dimming once calibration is complete.

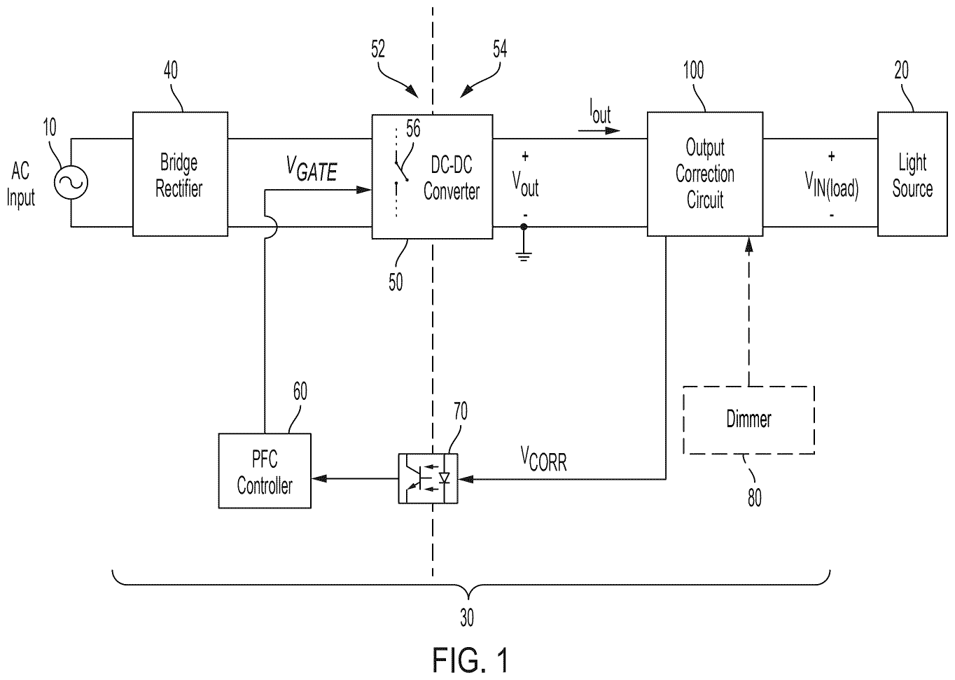

FIG. 1 illustrates a lighting system 1 including a light driver 30 with accurate dimming control, according to some example embodiments of the present disclosure.

According to some embodiments, the lighting system 1 includes an input source 10, a light source 20, and a light driver 30 for powering and controlling the brightness of the light source 20 based on the signal from the input source 10.

The input source 10 may include an alternating current (AC) power source that may operate at a voltage of 100 Vac, 120 Vac, 240 Vac, or 277 Vac, for example. The light source 20 may include one or more light-emitting-diodes (LEDs) or an arc or gas discharge lamp with electronic ballasts, such as high intensity discharge (HID) or fluorescent lights.

In some embodiments, the light driver 30 includes a rectifier 40, a converter 50, and an output correction circuit (e.g., a secondary-side output correction circuit) 100.

The rectifier 40 may provide a same polarity of output for either polarity of the AC signal from the input source 10. In some examples, the rectifier 40 may be a full-wave circuit using a center-tapped transformer, a full-wave bridge circuit with four diodes, a half-wave bridge circuit, or a multi-phase rectifier.

The converter (e.g., the DC-DC converter) 50 converts the rectified AC signal generated by the rectifier 40 into a drive signal for powering and controlling the brightness of the light source 20. In some embodiments, the converter 50 includes a boost converter for maintaining (or attempting to maintain) a constant DC bus voltage on its output while drawing a current that is in phase with and at the same frequency as the line voltage (by virtue of the power factor correction (PFC) controller 60). Another switched-mode converter (e.g., a transformer) inside the converter 50 produces the desired output voltage from the DC bus. The converter has a primary side 52 and a secondary side 54 that is electrically isolated from, and inductively coupled to, the primary side 52. In some examples, the PFC controller (also referred to as a primary controller) 60 may be configured to improve (e.g., increase) the power factor of the load on the input source 10 and reduce the total harmonic distortions (THD) of the light driver 30. The PFC controller 60 may be external to the converter 50, as shown in FIG. 1, or may be internal to the converter 50.

According to some embodiments, the output correction circuit 100 monitors the output (e.g., the output current) of the converter 50 on the secondary side and issues a correction signal that is fed back into the primary side 52 of the light driver 30. The correction signal may be utilized by the PFC controller 60 to drive the one or more main switches 56 within the converter 50, which determine the DC output level of the light driver 30.

In some examples, the converter 50 may utilize a resonant LLC driving mechanism for efficient transfer of energy from the primary side 52 to the secondary side 54 and thus the light source 20. The one or more main switches 56 of the converter 50 include two transistors (e.g., field effect transistors (FETs)) that are connected together in a push-pull configuration and produce a square wave (or a signal that is substantially like a square wave) that are filtered by an LC structure, and when the switching is done at the resonant frequency of the resonator, only the fundamental frequency (i.e., a sine wave) at the resonant frequency is passed to the output of the converter 50. This way all the power transmitted is real power, as opposed to imaginary power, which reduces unnecessary energy loss and improves the power conversion efficiency of the light driver 30.

In some embodiments, the light driver 30 is in electrical communication with a dimmer (e.g., a dimming control device) 80 that signals the output correction circuit 100 to modify the output signal (Vout) to correspond to a dimmer level. The dimmer 80 may have a wired or wireless connection with the output correction circuit 100. The dimmer interface may be a rocker interface, a tap interface, a slide interface, a rotary interface, or the like. A user may adjust the dimmer level by, for example, adjusting a position of a dimmer lever or a rotation of a rotary dimmer knob, or the like.

The output correction circuit 100 is electrically coupled to the secondary side 54 of the converter 50 and electrically isolated from the primary side 52. According to some embodiments, the output correction circuit 100 is configured to enter calibration mode based on changes in the dimmer level (e.g., movement of the dimmer slider or rotation of the dimmer rotary), and to program a maximum load current Iₘₐₓ at 100% dimmer level, and uses this maximum current Iₘₐₓ at 100% to determine the appropriate control signal (also referred as a correction signal) to achieve the desired dimmer level. In some embodiments, the output correction circuit 100 operates in constant voltage mode before and during calibration, and then switches to constant current mode once the calibration is complete.

In some examples, an optocoupler 70 communicates the control signal from the output correction circuit 100 on the secondary side 54 to the primary side 52 for regulating the primary side, while maintaining the electrical isolation between the two sides. The optocoupler 70 ensures that the control signal is transmitted without electrical interference between the primary and secondary sides 52 and 54.

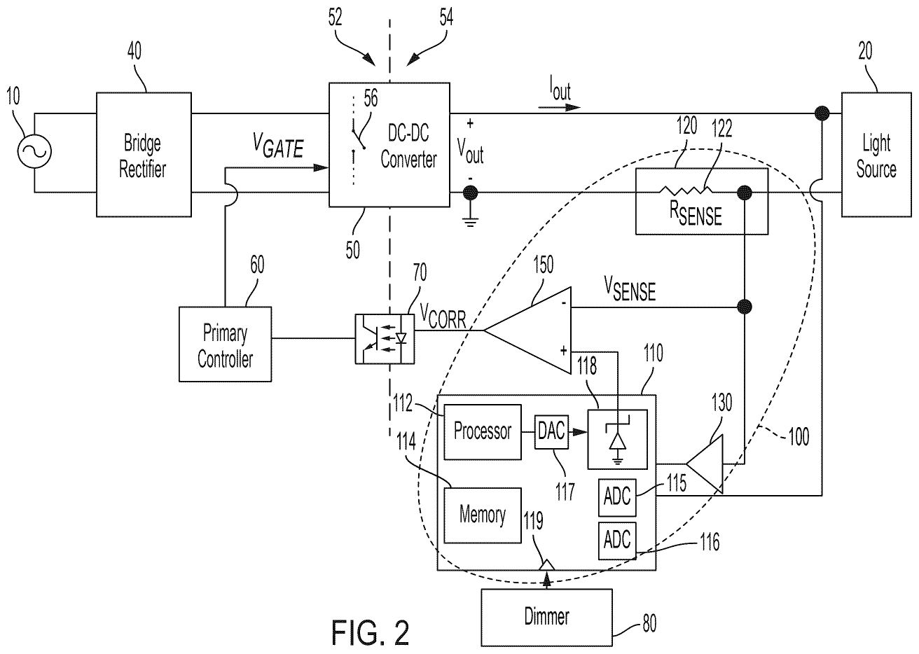

FIG. 2 illustrates the light driver 30 including the output correction circuit 100 capable of accurate dimming control according to some embodiments of the present disclosure.

In some embodiments, the output correction circuit 100 includes a controller (also referred to as a secondary controller) 110, a current sensor 120, and an error amplifier 150.

The current sensor 120 measures the drive current I_{OUT} that is output by the converter 50. In some examples, the current sensor 120 includes a sense resistor 122 that may be positioned between an output terminal (e.g., a reference/ground terminal) of the converter 50 and the light source 20 and is connected electrically in series with the light source 20 (e.g., at its negative input). In some examples, the sense resistor 122 may be about 50 mΩ to about 1Ω. As the sense resistor 102 is in a current path of the drive current I_{OUT}, the voltage (V_{SENSE}) at an end of the resistor 102 that is connected to light source 20 at node N_{S} corresponds to the drive current I_{OUT}. For example,

$${I}_{OUT} = {V}_{SENSE} / {R}_{SENSE} \qquad Eq . ( 1 )$$

While the above describes the current sensor as utilizing a series resistance, embodiments of the present disclosure are not limited thereto, and any other suitable current sensor, such as a hall effect sensor or the like, may be used.

As the sense signal V_{SENSE} may be too small to measure accurately, in some embodiments, the output correction circuit 100 further includes a signal amplifier 130 that is configured to amplify the sensed signal V_{SENSE} from the current sensor 120 and to supply the amplified signal to the controller 110 for processing. For example, the sense signal V_{SENSE} may have a magnitude of about 100 mV that is much lower than that input range (e.g., than that of the bias voltage of about 3.3 V) of the A/D converter at the input of the output correction circuit 100, which may make it difficult for the A/D converter to accurately measure the changes in sensed signal due to the limited resolution of the A/D converter. Accordingly, in some embodiments, the signal amplifier 130 amplifies the sensed signal to a value closer to the quantization reference of the A/D converter (e.g., closer to 3.3 V), which allows the A/D converter (and thus the controller) to more accurately measure changes in the amplified signal.

The controller 110 then generates a reference signal (e.g., a reference voltage) V_{REF} based on the output voltage V_{OUT} that is generated at output of the converter 50, a dimmer signal from the dimmer 80 and, depending on the mode of operation, the sense signal V_{SENSE} or the amplified signal. The dimmer signal may correspond to a desired DC-level of the drive signal output by the converter 50.

According to some embodiments, the controller 110 includes a processor (e.g., a programmable microprocessor or processing circuit) 112, a memory (e.g., a storage memory) 114, a first analog-to-digital (A/D) converter 115 to measure the (amplified) sense signal V_{SENSE}, a second analog-to-digital (A/D) converter 116 to measure the output voltage V_{OUT}, and a digital-to-analog (D/A) converter 117 to convert the output of the processor 112 to an analog signal. The first and second A/D converters 115 and 116 convert the corresponding readings to digital binary form for further processing by the processor 112. In some examples, the processor 112 generates a binary reference signal to dynamically control a DC-level of the drive signal of the converter 50 based on the dimmer signal and at least on one of the measured drive current I_{OUT} and the measured drive voltage V_{OUT}. The D/A converter 117 converts the binary reference signal to an analog reference signal for use by the error amplifier 150. In some examples, the processor 112 serves as the central processing unit of the controller 110 and manages data flow and executes control algorithms for the controller 110. The memory 114 provides storage for data and system configurations that are required for system operation.

As used herein, the terms “processor” and “processing circuit” include any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed wiring board (PWB) or distributed over several interconnected PWBs. A processing circuit may contain other processing circuits; for example, a processing circuit may include two processing circuits, an FPGA and a CPU, interconnected on a PWB.

In some embodiments, the controller 110 further includes a voltage regulator 118 for adjusting the voltage level of the analog reference signal output by the D/A converter 117 to a level for input to the error amplifier 150 (e.g., for input to the positive input terminal of the error amplifier 150). The voltage regulator 118 may be a shunt regulator that functions as a temperature-stable ideal Zener diode in which the maximum voltage (the clamp voltage) is set by the processor 112. The voltage regulator 118 may also serve as a back overvoltage protection device. The highest max voltage permitted by the voltage regulator 118 may be about 12 V, 24 V, 48 V, or any other suitable value.

The error amplifier 150 also receives the sensed output voltage V_{OUT} (e.g., at the negative input terminal of the error amplifier 150) in real-time and compares this signal to the reference signal V_{REF} and generates a correction signal (also referred to as a corrected control signal) V_{CORR} based on a difference (e.g., error) between the sensed signal and the reference signal. The correction signal V_{CORR} that is communicated by the optocoupler 70 is used by the PFC controller 60 to dynamically control the one or more main switches 56 of the converter 50 (e.g., via a gate control signal V_{GATE}), which in turn controls/adjusts the voltage level of the converter output V_{OUT}.

The circuit configuration of the light driver 30 described above ensures that output voltage V_{OUT} is regulated to the maximum voltage allowed by the dimmer 80 (e.g., 24 V at 100% dimmer level, 19 V at 50% dimmer level, etc.).

According to some embodiments, prior to calibration, the light driver 30 operates in constant voltage mode. Here, the controller 110 does not rely on the measured drive current I_{OUT} (i.e., ignores the reading from the first A/D converter 115, and instead relies (e.g., solely relies) on the measured drive voltage V_{OUT} and the dimmer level obtained from the dimmer 80 to produce a reference signal that regulates the output voltage V_{OUT} of the converter 50. In this mode, the controller 110 adjusts the output voltage V_{OUT} of the converter 50 based on the dimmer level using an internally-stored relationship between V_{OUT} and the dimmer level. For example, a 100% dimmer level may correspond to a V_{OUT} of 24 V, a 1% dimmer level may correspond to a V_{OUT} of 14 V, and a 0% dimmer level (i.e., light off) may correspond to a V_{OUT} of 8 V. Between 1% and 100% dimming, V_{OUT} may be linearly scaled between of 14 V and 24 V. However, embodiments of the present disclosure are not limited thereto, and the dimmer levels may be mapped to V_{OUT} in any suitable manner. In some examples, when the light driver 30 is in constant voltage mode, the mapping of dimmer values to output voltages V_{OUT} may be defined by a formula or a lookup table stored at the memory 114.

Because the light output of the light source 20 is proportional (or substantially proportional) to the drive current I_{OUT}, which is not being directly regulated in constant voltage mode, the light output may not accurately track or represent the dimmer level. For example, the voltage V_{OUT} corresponding to a 1% dimmer level may not necessarily produce a load current that is at 1% of the maximum current, and thus the light output of the light source 20 may not necessarily be at 1% light output. To resolve this issue and to produce accurate low dimming, the light driver 30 performs a calibration process to determine the maximum output current Iₘₐₓ of the converter 50 and switches to constant current mode once calibration is performed.

While in constant voltage mode, the controller 110 monitors the dimmer signal/level at the dimmer input (e.g., dimmer input pin or terminal) 119 of the controller 110 and enters dimmer calibration mode when it detects a calibration trigger or pattern from the dimmer 80. The calibration trigger or pattern may be a rapid succession of large swings in the dimmer level caused by rapid movements of the dimmer slider or rotations of the dimmer rotary that are unlike how a user would normally interact with the dimmer interface. This ensures that the light driver 30 does not accidentally enter dimmer calibration mode during normal use. In some examples, the controller 110 may enter calibration mode when it detects a plurality (i.e., two or more) large changes or swings (e.g., +/−40% changes) in dimmer level within a short period of time (e.g., within 1 second). However, embodiments of the present disclosure are not limited thereto and any suitable calibration pattern may be employed.

In some embodiments, once the controller 110 enters dimmer calibration mode, the controller 110 regulates the output voltage V_{OUT} of the converter 50 to its maximum voltage (e.g., 24 V) by setting the reference signal to its highest value, and measures the output current I_{OUT}. The controller 110 then stores this value, which is the maximum drive/load current when the dimmer level is at 100%, in the memory 114 as the maximum current Iₘₐₓ for later use.

According to some embodiments, once calibration is complete (e.g., once Iₘₐₓ is recorded), the light driver 30 switches to and remains in constant current mode. In this mode, the controller 110 monitors the output current I_{OUT} and directly regulates (e.g., via proportional-integral-derivative (PID) loop regulation) the output current I_{OUT} of the converter 50 to the appropriate value matching the dimmer level. In some embodiments, the regulated output current is scaled linearly with dimmer level. For example, at dimmer levels 100%, 50%, and 1%, the controller 110 may regulate the output current to Iₘₐₓ, 0.5× Iₘₐₓ, and 0.01× Iₘₐₓ, respectively. This ensures that the light output correctly tracks the dimmer level even down to 1% dimming. However, in some examples, the controller 110 may not allow the output current I_{OUT} to drop below a minimum current when dimming, which ensures that the light source (e.g., the LEDs making up the light source) do not turn off as a result of low current.

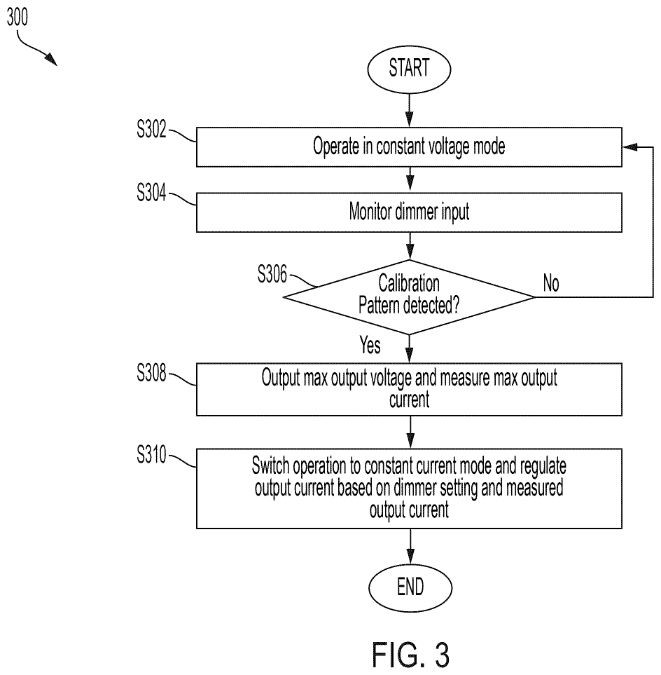

FIG. 3 is a flow diagram illustrating a process 300 of operating the light driver 30, which enables accurate dimming of the light source 20 by the light driver 30, according to some embodiments of the present disclosure.

In some embodiments, when not calibrated, the light driver 30 initially operates in constant voltage mode (S302) and monitors the dimmer input 119 of the controller 110, which is communicatively coupled to the dimmer 80, to detect a calibration pattern (S304). When operating in constant voltage mode, the controller 110 measures the output voltage V_{OUT} of the light driver 30 as a sampled voltage, and regulates the output voltage V_{OUT} of the light driver 30 based on the sampled voltage and the detected dimmer level (and not based on the output current I_{OUT}). In so doing, the controller 110 may generate a reference signal for controlling the output voltage V_{OUT} based on the sampled voltage and the dimmer level and by disregarding (or ignoring) current measurements at the output of the light driver 30. The uncalibrated light driver 30 remains in constant voltage mode until the calibration pattern is detected at the dimmer input 119.

When a calibration pattern is identified, the light driver 30 initiate calibration mode whereby it outputs the maximum output voltage that corresponds to a 100% dimming level, and measures and stores the drive current as a maximum current Iₘₐₓ (S308). Here, the maximum voltage may be the maximum voltage rating of the light driver 30. In some examples, identifying the calibration pattern at the dimmer input includes detecting a plurality of changes in the dimmer level (e.g., a change of 40% or more in the dimmer level) at the dimmer input 119 within a period of time (e.g., within 1 second).

Once calibration is complete (i.e., the controller 110 measures and stores the maximum current Iₘₐₓ), the light driver 30 switches to constant current mode operation, whereby it regulates the output current rather than the output voltage (S310). That is, the controller 110 measures the output current of the light driver 30 as a sampled current, and regulates the output current of the light driver based on the sampled current, the dimmer level received from the dimmer 80 and the recorded Iₘₐₓ.

Accordingly, as described above, the light driver with accurate dimming control, as described in the present disclosure, addresses the limitations of existing LED drivers by providing precise control over the current passing through the LEDs. The light driver ensures consistent and accurate light output even at low dimming levels, such as 1% dimming. The innovative design includes a rectifier, a DC-DC converter, and an output correction circuit that operates in constant voltage mode during calibration and switches to constant current mode post-calibration. This dual-mode operation, combined with the ability to dynamically adjust based on dimmer settings, allows for improved performance and user experience. The light driver is capable of achieving accurate low dimming, making it a significant advancement in the field of light drivers and LED technology.

It will be understood that, although the terms “first”, “second”, “third”, etc., may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of”, when preceding a list of elements, modify the entire list of elements and do not modify the individual elements of the list. Further, the use of “may” when describing embodiments of the inventive concept refers to “one or more embodiments of the inventive concept”. Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the terms “substantially”, “about”, and similar terms are used as terms of approximation and not as terms of degree, and are intended to account for the inherent variations in measured or calculated values that would be recognized by those of ordinary skill in the art.

As used herein, the terms “use”, “using”, and “used” may be considered synonymous with the terms “utilize”, “utilizing”, and “utilized”, respectively.

The light driver and/or any other relevant devices or components according to embodiments of the present disclosure described herein may be implemented by utilizing any suitable hardware, firmware (e.g., an application-specific integrated circuit), software, or a suitable combination of software, firmware, and hardware. For example, the various components of the light driver may be formed on one integrated circuit (IC) chip or on separate IC chips. Further, the various components of the light driver may be implemented on a flexible printed circuit film, a tape carrier package (TCP), a printed circuit board (PCB), or formed on the same substrate. Further, the various components of the light driver may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer-readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

What is claimed is:

1. A method of operating a light driver, the method comprising:
operating the light driver in a constant voltage mode;
identifying a calibration pattern at a dimmer input of the light driver;
generating a maximum voltage at an output of the light driver;
measuring a maximum current at the output of the light driver; and
operating the light driver in a constant current mode based on the maximum current and a dimmer level at the dimmer input.

2. The method of claim 1, wherein the operating the light driver in the constant voltage mode comprises:
measuring an output voltage of the light driver as a sampled voltage; and
regulating the output voltage of the light driver based on the sampled voltage and the dimmer level.

3. The method of claim 2, wherein the regulating the output voltage of the light driver comprises:
generating a reference signal for controlling the output voltage based on the sampled voltage and the dimmer level and by disregarding current measurements at the output of the light driver.

4. The method of claim 1, wherein the identifying the calibration pattern at the dimmer input comprises:
detecting a plurality of changes in the dimmer level at the dimmer input within a period of time.

5. The method of claim 4, wherein each of the plurality of changes in the dimmer level is a change of 40% or more in the dimmer level.

6. The method of claim 1, wherein the maximum voltage is a maximum voltage rating of the light driver.

7. The method of claim 1, wherein the operating the light driver in the constant current mode comprises:
measuring an output current of the light driver as a sampled current; and
regulating the output current of the light driver based on the sampled current and the dimmer level, and the.

8. The method of claim 7, wherein the regulating the output current of the light driver comprises:
generating a reference signal for controlling the output current based on the sampled current and the dimmer level.

9. The method of claim 8, wherein the light driver comprises:
a transformer defining a primary side and a secondary side of the light driver that are electrically isolated from one another; and
a secondary controller at the secondary side of the light driver and configured to generate the reference signal for transmission to a primary controller at the primary side of the light driver.

10. The method of claim 7, wherein the light driver is configured to drive a light source, and
wherein the dimmer input of the light driver is communicatively coupled to, and is configured to receive the dimmer level from, a dimmer.

11. A light driver comprising:
a converter configured to drive a light source at an output of the light driver;
a controller configured to perform:
controlling the converter to drive the light source in a constant voltage mode;
identifying a calibration pattern at a dimmer input of the controller;
controlling the converter to generate a maximum voltage at the output of the light driver;
measuring a maximum current at the output of the light driver; and
controlling the converter to drive the light source in a constant current mode based on the maximum current and a dimmer level at the dimmer input.

12. The light driver of claim 11, wherein the controlling the converter to drive the light source in the constant voltage mode comprises:
measuring, by the controller, an output voltage of the converter as a sampled voltage; and
regulating, by the controller, the output voltage of the converter based on the sampled voltage and the dimmer level.

13. The light driver of claim 12, wherein the regulating the output voltage of the light driver comprises:
generating, by the controller, a reference signal for controlling the output voltage based on the sampled voltage and the dimmer level and by disregarding current measurements at the output of the converter.

14. The light driver of claim 11, wherein the identifying the calibration pattern at the dimmer input comprises:
detecting, by the controller, a plurality of changes in the dimmer level at the dimmer input within a period of time.

15. The light driver of claim 14, wherein each of the plurality of changes in the dimmer level is a change of 40% or more in the dimmer level.

16. The light driver of claim 11, wherein the maximum voltage is a maximum voltage rating of the light driver.

17. The light driver of claim 11, wherein the controlling the converter to drive the light source in the constant current mode comprises:
measuring, by the controller, an output current of the converter as a sampled current; and
regulating, by the controller, the output current of the converter based on the sampled current and the dimmer level.

18. The light driver of claim 17, wherein the regulating the output current of the light driver comprises:
generating, by the controller, a reference signal for controlling the output current based on the sampled current and the dimmer level.

19. The light driver of claim 11, further comprising:
a rectifier configured to rectify an input line voltage to generate a rectified input line voltage,
wherein the converter is configured to convert the rectified input line voltage into a drive signal for powering the light source,
wherein the input line voltage from which the rectified input line voltage is generated is from 100 Vac to 277 Vac.

20. The light driver of claim 11, wherein the dimmer input of the dimmer input of the controller is communicatively coupled to, and is configured to receive the dimmer level from, a dimmer.
